(19) United States
(12) Patent Application Publication
(10) Pub. No.: US 2020/0058231 A1
(43) Pub. Date: Feb. 20, 2020

(54) iWay

(71) Applicant: Mark Larick, Austin, TX (US)

(72) Inventor: Mark Larick, Austin, TX (US)

(21) Appl. No.: 16/105,331

(22) Filed: Aug. 20, 2018

(51) Int. Cl. G09B 19/00

(52) U.S. Cl. CPC G09B 19/0053

(57) ABSTRACT

iWay is an innovative, novel approach and method that uses the metaphor of the automobile as teaching tools to instruct students about the basics of computers, computer operations, navigations and online resources. All types of teaching media will be created, but the computer software edition will enable the user to open different computer programs by command, creating “a window for Windows” (or “a GUI for the GUI”). While a new educational process is the main thrust of the program, having a central command center which reduces keystrokes and simplifies computer navigation is part of this improved process of instruction. It is possible that browsers, applications and programs (such as the Chrome browser, Skype, iTunes and others) can appear within the Uncle Tucker program as a plug in while they are activated.

### TITLE OF THE INVENTION

iWay—A guided, customizable, interactive program (software, printed media, television, internet episodes and others) that teaches computer navigation using the metaphor of the automobile.

### CROSS-REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

Most instructive how-to computer guides do not tap into life experiences and knowledge that students already possess, which can be valuable tools to communicate. These mass market one-size fits all approaches do not instill confidence; they miss a personal touch and lack fun. The instruction manuals weigh more than tablet computers. They seem intimidating and disheartening. A tour of one of the leading manuals does not even begin to address email until page 229. While these professionals do a very thorough job documenting a guide to beginning computing, they lack a more dynamic learning environment. They lack feedback and true participation. One free online tutorial walks you through 7 pages of instructions of an “introduction to email” without actually providing examples or to have students fill in the necessary parts. These are just some of the disadvantages of the prior art solutions, and for the foregoing reasons, there is a need for this improved and innovative process.

### OBJECT OF INVENTION

Metaphors have been used for centuries to instruct, inspire, enlighten, and give meaning and value to broad populations. The existing problems of the prior art will be addressed in this innovative, novel, non-obvious process that iWay offers. Through voice, animations and graphics, the student will be guided through the process as if they were driving a car and other associated automotive functions. Each topic, such as an introduction to the platform's email program, will appear on the computer screen with innovative media attached which will guide the user gently through the various line by line instructions. Points will be reinforced to the pupil with how these line by line instructions, the actions and reactions, are already in their knowledge base (just like backing out a car) and are now being applied to the navigation of a computer. As a knowledgeable presence is always with them, the student gains more confidence and does not feel abandoned like trying to track down a certain page or chapter in the instruction manual they read last week. The opening graphic and home base of the program will serve as a launching pad to the available applications, offer a pre-visualization of subject matter to come, and then execute the subsequent steps. Another advantage of this interface is a car pool function that will match users' age and interests to communicate in a social network to compare each others' progress, or chat about any topics that they choose.

### STATEMENT OF INVENTION

The inventive features of this invention will enable the students to apply the core concept, that of the metaphor of the automobile, to all of the options available on the computer. There are many valuable advantages in having a simple, relatable and elegant path to which all of the computer's functions can be explained and detailed. The prior art lack such a uniting theory or approach; they all treat the various programs as standing alone, and do not adequately provide a system which can address and solve all of the teaching solutions.

### SUMMARY

The purpose of the invention is to introduce and guide students through the functions and capabilities of modern computing. There is a huge segment of society-the elderly and recently retired-which will be a targeted group for this product. They feel a strong interest in learning in general, and computer learning in particular, because they agree that computers present constant mental challenges and thus are useful for keeping the mind active. This program will also act as a communication tool to reach out to family and grand children at an often isolating point of their lives. This advantageous process offers a much more thorough and personal structure than present teaching matter affords. It accesses skills and experiences already inherent in the user's body of knowledge and life experiences, thus connecting to a deeper, richer understanding to the solving of problems. This effective use of instruction will be available in all possible media formats: Software, television programs, Internet tutorials, printed materials, and others. These and other features, aspects, and advantages of the present invention will become better understood with reference to the following descriptions and claims.

### BRIEF DESCRIPTION OF THE DRAWING

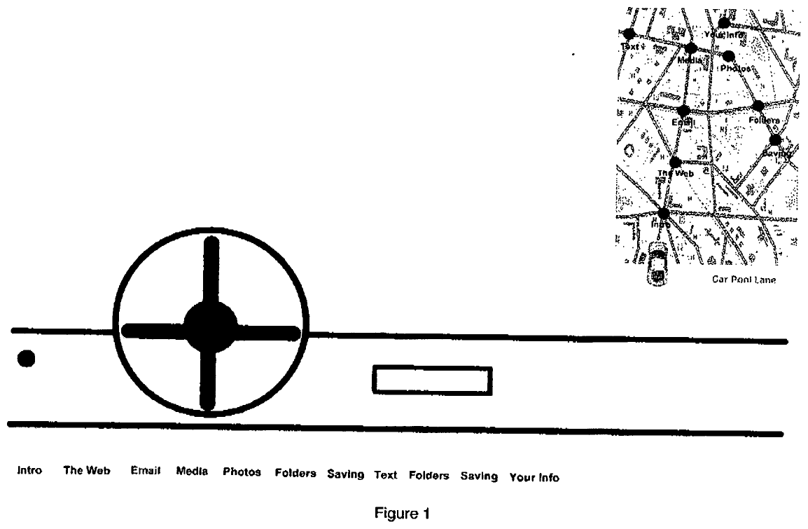

A prophetic example of the users screen could look like FIG. 1. This example is meant only to illustrate, but in no way limit this claimed invention.

With this simple, elegant interface, the metaphor of the automobile compares the line by line instructions that are necessary to achieve desired destinations. Again, the prior art does not adequately tap into the knowledge base, skills and life experiences that customers already possess in successfully stringing together commands to navigate journeys, arrive at destinations and follow paths.

### DETAILED DESCRIPTION OF THE INVENTION

iWay accesses the student's innate knowledge, of comparing new computer instruction to the experience of driving a car. This broad view taps into a space not explored in present day computer instruction. This bedrock concept, that of comparing the computer to an automobile, will enable the student to visualize the branches and buds that grow from this core. This training program also gives support and nurturing along the way, fending off the frustration experienced by new learners. This new, improved concept and method of a guided learning is a vast improvement and what distinguishes it over the prior art.

Java, or C++, will be implemented to create the software edition in a game style interface, and said software will be able to run on all current platforms. Voice, text, music and animated graphics will be created to extend the automotive metaphor in a direct, simple method and the construction of the program will at all times seek to reinforce learning, and encourage confidence, all while continuing to illustrate the nature of computer navigations. To install the program into the user's computer, the software will be available by conventional means, on a disk, and/or be available as a digital download to customers with an internet connection. Upgrades will be available via the mail or internet.

Once iWay is installed and opened, as by choice or as the default start-up program, it will announce it is ready with a cheerful auto horn “Beep Beep”! The user then “gets in the car”, and a keystroke triggers a door slamming sound “Thunk”. The opening greeting could go something like this:

“Your ride is here, and the world is at your feet. Like any machine, we have to tell the computer what we want to do. If you turn on a car, it will just sit there and run, YOU have to give it instructions to go in reverse, (or straight, left, or right). We are right here with you, always! So there is no need to fear the unknown. You already possess the knowledge to maneuver and manipulate a machine and solve problems. We are going to use your previous skills to quickly get you going on the road!”

“Like any decision you make in your car, you need to select the device you want to work: If you want to hear music, or news in your car, you need to turn on the radio. As you well know, honking the horn will not play the radio-you have to consciously choose the radio! On this Mac computer, your radio is iTunes. Click it to open it now. Here you can listen to and buy your favorite music.”

An animation featuring the iTunes button and the iWay dashboard radio is featured while the text appears: “Turning on the radio”. Through computer scripts and code, iWay will execute these tasks and more.

This casual approach will be used in the instruction to put the user at ease. The aim is to slowly build confidence and competence with the user, providing a window for windows, or a GUI for the GUI-making decisions and selections simpler by avoiding the clutter of too many options. As users progress after mastering the basic introduction, having heard a particular explanation numerous times, a more technically advanced audio and graphic introduction can be selected. It is planned that several versions of the audio will be selectable for the instructions. If the user is a country Western music fan, a celebrity will be hired for one version of the audio while race fans will be able to select a racing driver of note that will be hired for that version. Other options could include, but not limit, celebrities from comedy, finance, television, music, news, athletics, politics and/or others. It is also possible that a sponsor could be found to use their characters to serve as instructors. Graphics will also be customizable. This will offer the users their choice of “rides”, be it a Volkswagen bus, a Chevy Camaro, a 1932 Ford sedan and others. Turn signals can be activated when the user changes topics, fuzzy dice can be suspended in the rear view mirror and the like.

This process will be extended and implemented for all of the software programs on the customer's computer, such as email, web browsers, text editing and the like. All of the options will open with audio guidance which goes back to the automobile core concept, having a path, a destination, and the skills already inherent in the user. It is desired and planned that the software will be created to listen and respond to the users' voice requests.

The tutorials will be arranged in a sequence that will grow from simple selections while skill building to lay the groundwork to more complex computing issues. To address the more complicated concept of folders and filing, the use of visors, consoles and ashtrays will be used. The audio might go thusly:

“You just pulled into a parking garage and you dare not lose you ticket. You need to put it somewhere that you will remember! Do you put it in your console? Do you stash it in your ashtray? Or how about your visor, or your glove compartment? You need to put it in a place that you will remember, so that you can retrieve it. Now think of the path; car-ashtray. Or maybe it is car-glove compartment-sunglasses case. Your folders are arranged in just such fashion”

As the user becomes more comfortable with the learning process, they will be able to create a dock of their most used programs to appear within the “window” of the program, creating an alias that triggers and opens said programs. This ability to customize the software will be handled with the same tutoring and guidance media as has been mentioned above.

According to a study published in the journal Educational Gerontology (Volume 34 Issue 9, 2008), the barriers to learning computers include frustration, physical and mental limitations, mistrust, and time issues. This training program implements and addresses these problems thoroughly and simply and is a great improvement over the prior art. This training program will provide crucial understandings, computing confidence and a broad view of all of the interrelated computing elements to customers than has previously been made available.

Although the present invention has been described in considerable detail with reference to certain preferred versions thereof, other versions are possible. Therefore, the spirit and scope of the appended claims should not be limited to the description of the preferred versions contained therein.

The embodiment of the invention in which an exclusive property or privilege is claimed as follows:

1. A guided, interactive teaching process program containing voice and graphics that uses the metaphor of the automobile and its functions to instruct users and train and simplify the navigation of the computer, its software and online resources.

2. An animated, interactive and customizable opening program of claim 1 including a graphic interface that greets and instructs users and reminds them of previous progress while serving as the control center screen, which is activated and accessed by touchscreen, voice commands, keyboard, mouse selections and or other connective computing devices.

3. An animated, interactive and customizable road map of claim 1 comprising elements that will trace users' progress, suggest and provide future training destinations and subjects, and serve as a portal to launch other software programs; each opening with detailed guidance media attached to said newly opened program.

4. A customizable, animated car pool including graphics of claim 1 that will enable students to interact and share this learning process with the programs' online community of users and devotees.
